(19) United States
(12) Patent Application Publication
(10) Pub. No.: US 2002/0138176 A1
(43) Pub. Date: Sep. 26, 2002

(54) Automated aggregation and management of distributed electric load reduction

(76) Inventors: Patrick Davis, Pflugerville, TX (US); William Stevens Taber JR., San Anselmo, CA (US); Greg S. Mattison, Round Rock, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/774,751

(22) Filed: Jan. 30, 2001

Related U.S. Application Data
(60) Provisional application No. 60/179,456, filed on Feb. 1, 2000.

(51) Int. Cl. G05D 3/12

(52) U.S. Cl. 700/286

(57) ABSTRACT

The present invention provides means and methods for the automated aggregation and management of distributed electric load reduction.

### BACKGROUND OF THE INVENTION

A. Electric Industry Structure: Physical Structure

The traditional physical structure of the electric utility is a “hub & spokes” model, with the generating capacity located in a single location or a few central locations, a transmission system (analogous to arteries) transmitting power in a single direction toward user regions, and a distribution system (analogous to capillaries) delivering the power to the end users. This industry model worked well for many decades, because of the economies of scale available by increasing the size of the central generating stations, resulting in greater economic efficiencies. In general, this industry model was designed so that the capacities of the generation, transmission, and distribution systems were sized to the maximum demand expected at any time; as a result, the systems were less than fully utilized most of the time.

The traditional hub & spokes model of the electric industry is predicted by some industry experts to be giving way to a Distributed Generation model (analogous to the shift in the computer industry from central computers to networked computers). This shift is being driven by several factors, including the following:

1) Central generating stations have reached the limits of increasing economies of scale.

2) Some utility executives in the past made some unwise investments in central stations, especially those utilizing nuclear power, which proved to be expensive both to build and to operate.

3) Very reliable, fuel-efficient small generators, based on jet engine technology and manufactured in large quantities, have become commercially available at low capital and operating cost. Their small size makes it economical to deploy them throughout the transmission and distribution system.

4) Generators placed close to the loads which they serve avoid most of the friction losses which are inevitable in transmission & distribution systems.

5) Generators placed close to the loads which they serve can in some cases realize additional efficiencies by utilizing their waste heat to serve thermal loads.

6) When deployed in areas where the transmission and/or distribution systems are constrained and unable to meet peak demands, distributed generators enjoy additional economic advantages by obviating investments in upgrading the transmission and distribution systems. Distributed generators can also “strengthen” grids in areas of weakness (i.e., in areas of low power quality or voltage fluctuations). ¹. Transmission & distribution losses are inevitable except in systems which operate at temperatures close to absolute zero. In a typical well-run system, these losses generally amount to a few percent of the total power throughput.

Distributed generation, however, often has an important economic disadvantage, in that, if it is deployed in circumstances where the existing generation, transmission, or distribution assets are underutilized, distributed generation deprives the existing assets of customers. This is particularly important with respect to the distribution utility, which must maintain its distribution system in order to fulfill its “obligation to serve” but which loses to the distributed generation investment a customer to share the cost of the distribution system with its neighbors.

B. Electric Industry Structure: Business Structure

The traditional structure of the electric industry has been that of a vertically integrated regulated monopoly, in which investor-owned companies were granted the exclusive right to provide electricity in defined service areas, at defined rates of return on their investments, and in which those companies accepted, (1) a high degree of regulation, (2) an obligation to serve all customers in their service areas, and (3) an obligation to maintain reliable electric service.

Since 1979 (in the United Kingdom) and more recently in the United States, electric industries have been restructured, generally following the principle that the vertically integrated, “bundled” electric services formerly provided by a monopoly supplier have been “unbundled”, as follows:

1) Generation has been made competitive, with transactions conducted directly between buyers and sellers of power. Markets have been established for the buying and selling of power.

2) Transmission assets have remained privately owned, but access to them by buyers and sellers of power has been made open and freely available on a nondiscriminatory basis. In other words, owners of transmission assets are generally not permitted to use them to provide market advantage to any particular seller of power. Operation of the transmission system has often been moved from the monopoly utilities operating exclusively within their service areas to an Independent System Operator (ISO) operating the transmission system in a region which typically comprises several utility service areas. The ISO has received the obligation to maintain the reliability and stability of the generation and transmission systems.

3) Distribution has remained a regulated monopoly. Distribution utilities have retained their obligation to serve all customers in their service area and their obligation to maintain the reliability of the distribution system (but not the generation or transmission systems).

4) Ancillary services, including reserves (see below), have been made competitive.

5) Other activities (e.g., metering and billing) have be made competitive

C. Dispatch of Generating Resources

Prior to electric industry restructuring, generators are “dispatched” (i.e., mobilized to deliver power into the transmission system) by the monopoly electric utility in response to the load which occurs within the utility's monopoly service area. As load increases, the utility system operator dispatches that set of generators which most economically meets the load. Under electric industry restructuring, this dispatch function is in some cases moved to an Independent System Operator (ISO), which operates the transmission system through which all generators deliver power to power users.

In either case, an important distinction is made between generators which are scheduled to meet load and generators which provide reserves. The system operator must have available scheduled generators, which are dispatched to meet anticipated load, and in addition must have generators held in reserve, which are available to be dispatched in the event that an operating generator experiences an unscheduled outage or in the event that demand increases to a greater degree than anticipated. These generation reserves are generally categorized according to their maximum advance notice for dispatch, as follows:

| | Reserve Category | Maximum advance notice |
|---|---|---|
| Dispatch Priority | (common name) | for dispatch |
| 1 | Voltage support | immediate |
| 2 | Spinning reserve | 10 minutes |
| 3 | Non-spinning reserve | 1 hour |
| 4 | Stand-by reserve | 4 hours |

Definitions of the various categories of generation reserves vary from location to location, using different names for categories of generation reserves, different dispatch times for categories of generation reserves, and different ways of measuring the resources committed within the dispatch period.

Prior to industry restructuring, reserves can be provided by the monopoly utility or can be procured by the monopoly utility from third parties. Under industry restructuring, reserves are typically procured competitively by the ISO or the utilities. In either case, reserves can be procured either (1) from owners of generating assets who elect to sell their generating capacity as reserves rather than as scheduled generators or (2) from users of electric power who elect to reduce (“shed”) their load. In the latter case, we are aware of three models for load “shedding” (which we refer to herein as “Load Reduction” or “Distributed Load Reduction” “DLR”). Three existing models have typically been used as stand-by (4 hour) reserves because of the time required to dispatch them.

1. Residential Air Conditioners Shut-off

Residential air conditioners are fitted with a radio-activated shut-off device which is operated centrally for the purpose of DLR. However, these devices are easily, and often, defeated by the customers, so this technique for DLR is not entirely reliable and is not easily measured for purposes of system operation. Moreover, the shut-off devices do not include a means of verifying the operability of the device or its operative engagement or its disengagement of the air conditioner from the power supply.

2. Emergency Generator Dispatch

Facilities equipped with emergency generators, such as hospitals, are contacted, typically by telephone, and asked to dispatch their emergency generator to reduce their power requirements from the distribution system. This is typically accomplished by the transmission system operator contacting either a central dispatch operator or the end-users directly, requesting that they turn on their respective backup generators, thereby taking the load assigned to the generators off the external generation, transmission, and distribution systems. This technique for DLR requires a substantial amount of person-to-person communications and the manual actuation of a switch to energize and subsequently de-energize the generator.

The emergency dispatch method has not been coupled with a system for rapid communication and, thus, cannot respond instantaneously to changes in conditions in the external generation, transmission and distribution and in the market for electricity. Moreover, without the incorporation of rapid communication into the method, there is no way to instantaneously deploy DLR to where its economic value is maximized. Additionally, without a means for rapid communication, the prior methods cannot instantaneously verify the power production and power quality of the system.

3. Power Requirement Deferment

Very large power users that have flexible schedules for power use, such as water utilities and agricultural irrigators, defer their power requirements to non-peak-demand periods. This has been regarded as a reliable generation reserve where the loads are large, identifiable pieces of equipment (such as irrigation pumps) the impacts of which on the transmission system are obvious from the operating characteristics of the transmission system itself, without measuring the activity of the end use equipment.

In view of the discussion above, a method and device for performing distributed load reduction that is verifiable, automated and that responds substantially instantaneously to changes in energy load would represent a significant advance in the art. The present invention provides such methods and devices.

### SUMMARY OF THE INVENTION

The present invention provides for the rapid and efficient deployment of DLR through the internet, or other forms of rapid communication. Unlike prior methods, the present invention provides a means to respond instantaneously to changes in conditions in the external generation, transmission and distribution, and in the market for electricity. Moreover, the incorporation of rapid communication into the method allows the instantaneous deployment of DLR to where its economic value is maximized. Additionally, using a means of rapid communication, the present methods is capable of instantaneously verifying the power production and power quality of the system.

Thus, in a first aspect, the present invention uses “Distributed Generator Dispatch,” in which generating equipment located within power users' facilities, including emergency generators, is dispatched to reduce the power requirements of their respective facilities which are served by the external electric generation, transmission, and distribution systems.

In a second aspect, the present invention utilizes “End Use Equipment Electric Load Control”, in which facility end use equipment, such as chillers, fans, and lighting, is controlled in a number of ways. In a preferred embodiment, the end use equipment is staged to reduce load, i.e., it is operated in controlled sequences which causes the total load during peak periods to approximate the average load during peak periods, thereby reducing the maximum load.

In another preferred embodiment, the end use equipment is throttled back to reduce load. Under normal circumstances, such equipment operates to keep building environments within generally accepted, prescribed comfort “envelopes”. However, building occupants generally tolerate quite well (and usually do not notice) short-lived migrations out of the comfort envelopes. Throttling back the equipment enables the user of the invention to reduce the power requirements of the equipment, thereby enabling the facility to shed load. In addition, users of the invention can take measures (such as pre-cooling the thermal mass of a building) to mitigate the impact of such migrations on the comfort conditions of the building.

DLR creates economic value by providing power reserves, in each of the techniques by which reserves are procured under prevailing market conditions. There is no inherent barrier to DLR, particularly in any of the four common categories of reserves provided that the dispatch and measurement of the generation asset meets the applicable system requirements of maximum advance notice for dispatch.

Other exemplary embodiments include, but are not limited to, “Real-Time Price Signal Response.” Although most bundled electric services deliver power to customers at time-weighted average prices without regard for when the power is used, power in fact has highly time-specific value. That is, during peak demand conditions, power is much more valuable than during non-peak conditions. This follows generally from the laws of supply and demand, and it follows specifically from the fact that the most cost-efficient generators operate most of the time (meeting “base load”), while the least efficient generators, which are typically the most expensive to operate, operate only when power supplies are short and value is high (“peak load”). DLR during conditions of peak demand effectively displaces the need for high cost power.

The ways in which Real-Time Price Signal Response creates value include, for example, bundled electric service, which creates value for the utility that can be recognized and shared with the customer by offering the customer lower average rates in consideration for the customer accepting interruptible power. Real-Time Price Signal Response also creates value, in connection with unbundled electric service, where the real the price of power is visible to the customer. This creates value for the customer, who can avoid buying power when the cost is highest.

DLR also functions as the most “distributed” of distributed generation resources, taking place not only close to, but within, the load. As such, DLR enjoys all of the economic advantages of distributed generation, including the deferment of investments in upgraded transmission and distribution infrastructure. In addition, DLR avoids the economic disadvantage of distributed generation, in that it is typically utilized only under peak conditions when the generation, transmission, and distribution systems are under stress.

The present invention provides for the rapid and efficient deployment of DLR through the internet or other rapid communication means. In preferred embodiments, the invention accomplishes DLR through Distributed Generator Dispatch and/or End Use Equipment Electric Load Control.

Other objects and advantages of the present invention will be apparent from a review of the detailed description that follows.

### BRIEF DESCRIPTION OF THE DRAWINGS

FIG. 1 is a schematic diagram of an embodiment of the method of the invention.

FIG. 2 is a schematic diagram of an embodiment of the invention utilizing a wide area network, such as the World Wide Web to receive and transmit information.

### DETAILED DESCRIPTION OF THE INVENTION AND THE PREFERRED EMBODIMENTS

Definitions

“Auto Transfer Switch” (ATS), as used herein, refers to an electrical switch that automatically switches the electrical service being supplied from the primary electrical source (usually the power incoming from a utility company) to a backup source such as an emergency generator in the event of low power quality or interruption of electrical service. The switch is preferably substantially instantaneous.

“Backup Generators,” as used herein, refers to electrical generators used to supply emergency power in the event of a power failure or in some case for low power quality. The generators are usually powered by diesel fuel or natural gas, and they can also include fuel cells used for similar purposes.

“Generators or Generating Equipment,” as used herein, refers to devices for the production of electric power, including fuel-fired internal combustion engines, fuel-fired turbines, fuel cells, etc.

“Load Aggregation,” as used herein, refers to a strategy of combining various loads from numerous locations into one manageable load.

“V-gen Server,” as used herein, refers to a device, such as a computer, which preferably operates from the virtual center of the present invention, acquiring and processing data that actuates deployment of the system resources and initiating deployment activities.

“V-gen Hub”, as used herein, refers to a device, such as a computer, which preferably operates immediately downstream of the V-gen Server and preferably controls dispatch, data acquisition and storage, and system optimization functions in a local or regional area.

“V-gen Control Panel,” as used herein, refers to a device, located on or near a piece or pieces of end use or generation equipment within a facility, which preferably initiates or controls the operation of the equipment.

“V-gen System,” as used herein, refers to the entire system of control devices and power resources which is deployed using the present invention

Introduction

It is an object of the present invention to create economic value based on increasing the efficiency of processes utilizing energy and other resources.

The present invention creates economic value in a number of ways, including, for example, generating energy (e.g., electrical power) reserves, providing real-time price signal response and through distributed generation benefits.

The present invention provides for the rapid and efficient deployment of DLR. It incorporates a backbone of high speed communication, preferably utilizing Transmission Control Protocol/Internet Protocol (TCP/IP) communications to accomplish DLR.

It is an object of the present invention to provide a means to automate the deployment of DLR. This enables DLR to be deployed substantially instantaneously, moving it up the “value chain” of generation reserves to where its economic value is maximized. In addition, it enables it to respond substantially instantaneously to changing conditions in the external generation, transmission, and distribution systems and in the market for electricity.

It is also an object of the present invention to deploy DLR using high-speed communications, including the Internet. This enables DLR to be rapidly verified by substantially real-time response, measured with precision, and treated as a external system resource (e.g., a generation reserve). In addition, it enables a substantially instantaneous response to changing conditions in the external generation, transmission, and distribution systems and in the market for electricity.

Yet a further object of the present invention is to provide a means for resource aggregation. DLR can operate with resources located within the facilities of individual customers of the electric utility but aggregated to include resources from more than one such customer. This enables the user of the present invention to deploy a large enough resource to be quantitatively significant to the external electric generation, transmission, and distribution systems and usable as a system resource for planning to meet total electric demand. In essence, the present invention creates a large, virtual power plant, located at one or more nodes on an electric distribution system.

Still a further object of the present invention is the provision of disaggregated measurement. The present invention preferably acquires and uses real-time information concerning the individual pieces of equipment within each customer's facility, rather than facility-level information acquired at the customer's interface with the electric distribution system (the meter). This enables precise measurement and control of the deployment of resources, and it enables the distinction between effects on load from the deployment of the subject resources and unrelated effects on load from other factors such as weather. Because the invention deploys resources entirely within each customer's facility, the user of the invention can deploy the virtual power plant while avoiding the technical challenges and cost of interconnecting generating facilities with the transmission and distribution systems. Moreover, the present invention provides a DLR resource that is preferably deployed in such a way as to be instantly measurable with considerable precision.

The objects and advantages of the present invention are further illustrated by two exemplary applications utilizing distributed generator dispatch and end use equipment demand control.

Technique 1: Distributed Generator Dispatch

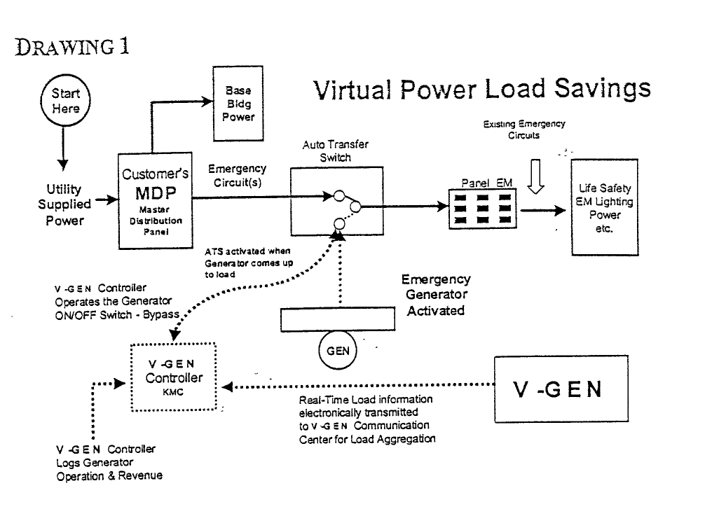

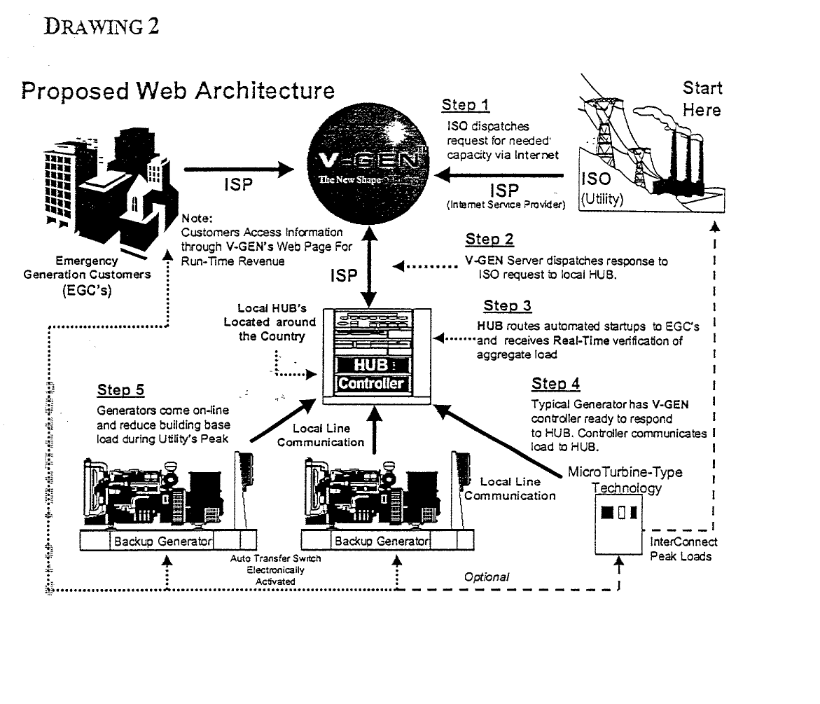

In an exemplary technique, generating equipment located within power users' facilities, including emergency generators, is dispatched to reduce the power requirements of their respective facilities, which are served by the external electric generation, transmission, and distribution systems. An illustrative application of this technique is described below and in FIG. 1 and FIG. 2.

In this exemplary application of the technique, dispatch is initiated by the main V-GEN Server when the conditions for initiating deployment are favorable. Such conditions might be a procurement action by a utility or an ISO seeking reserves, market conditions, or physical conditions in the transmission and distribution systems. When such conditions prevail, the main V-GEN Server deploys a signal to the regional V-GEN Hub whose location is appropriate for response (different sections of transmission and distribution systems are usually under varying degrees of utilization and therefore stress, so congestion will typically occur only in certain portions of a transmission and distribution system). The signal is routed via the internet to the local V-GEN Hub.

This exemplary application of the technique can utilize a field-installed or factory-installed, proprietary, application-specific V-GEN Control Panel on the generator(s) within each customer's facility. The V-GEN panel typically includes an input/output networkable controller. In one embodiment, the controller has firmware programmed to specifically carry out optimized sequences, either predetermined or determined in real-time, to energize generators in response to a deployment signal from the central V-GEN Server through the local V-GEN Hub. These controllers have about 8 inputs and about 8 outputs on board. The inputs are preferably analog. The inputs accept a signal that is about 0 to about 5 vdc or about 4 to about 20 ma. The outputs are preferably analog outputs of from about 0 to about 12 vdc. The signal input and analog outputs are industry standards and they are generally compatible with most third party transmitters and controls devices. The panel has a common protocol allowing it to communicate with other controllers to carry out complicated sequences of demand reduction.

In an exemplary application, when the deployment signal is received by the local V-GEN Hub, the V-GEN Hub dispatches a signal via the local phone system to the various V-GEN Control Panels. Each V-GEN Control Panel preferably sends a start signal to the respective generator. The generator is preferably started per the manufacturer's start sequence. The start sequence preferably includes the actuation of the auto transfer switch (ATS), which disables the utility-provided power in favor of the generator-provided power. This is preferably accomplished in such a way that there is no interruption of electric service to the facility. The sequence of the start-up of the generator and the transfer switch is a generator manufacturer-provided control sequence, initiated and maintained by the original equipment manufacturer's proprietary controller. The V-GEN Control Panel sends a start signal to the OEM controller on the generator. The V-GEN panel monitors the output of the generator to calculate the real time load on the generator thus the real time load reduction in the external generation, transmission, and distribution systems. This information is transmitted to the V-GEN Hub and V-GEN Server. The V-GEN Hub and Server monitor the conditions for deployment and the performance of the V-GEN resources constantly, continually optimizing the deployment in response to changing conditions.

In procuring reserves, transmission system operators generally procure reserves in fixed amounts, corresponding to the fact that generators have fixed output capacities under specified environmental conditions. In a preferred embodiment, the present invention will preferably dispatch generating assets in response to load conditions within a facility as well as in the generation, transmission, and distribution systems. Since the conditions within the facility may vary, the output of the resources deployed by the invention may also vary.

Procuring reserves, as described above, will generally have two ramifications. First, real-time variance in conditions within a facility will, to some extent, track variance in conditions in the local distribution system. For example, if a city block falls under a cloud, the load on all the air conditioning systems in that block will be reduced, and the electric demand on the distribution system in that block will be reduced. Thus, a rough correspondence will exist between the micro-deployment of generating assets and the micro-grid conditions. Moreover, throughout the V-GEN system, the V-GEN Server will control the aggregation and dispatch of generating assets to ensure that the obligations of the user of the invention to provide committed reserves are met.

In a preferred example, the V-GEN Server and Hub are hotlinked to the computers which control the external transmission and distribution systems to accommodate real-time micro- and macro-variance in reserve requirements. In a further preferred example, the hotlink is accomplished by using OPC {OLE [Object Linking and Imbedding] Process Control}.

The use of the local V-GEN Hub as an intermediary in the communication link between the V-GEN Server and the V-GEN Control Panel enables the internet interface to be regional and the local communications to use other forms of high-speed communication, such as telephone or 2-way radio. This in turn enables the V-GEN Control Panel to have an inexpensive communication device, rather than an internet-capable computer. In addition to the internet backbone, the present invention can use substantially any form of rapid communication, including, for example, telephone, radio, or satellite based communication techniques.

This exemplary application of the present invention preferably includes the following elements:

1) The V-GEN System is electronically linked to the computers monitoring and controlling the external generation, transmission, and distribution systems, with programmed thresholds affecting the deployment of the V-GEN system resources. Each set of conditions for deployment of resources which is received by the V-GEN Server has a territory and a quantity of reserve inherent to it. The V-GEN system transmits the appropriate deployment instruction to the appropriate V-GEN Hub. The V-GEN Hub dispatches the start-up signals and data-logs the response. The aggregated response quantity is mathematically compared the deployment request quantity by the V-GEN Hub and Server.

2) The V-GEN System provides an aggregated, quantified response to the deployment signal, monitoring and energizing the needed generators to fit precisely the quantity of demand reduction which is optimal under the prevailing conditions for deployment. For example, if a transmission system operator needs 5.1 megawatts (mW) of spinning reserve and 10.3 mW of the non-spinning reserve, the present invention can deploy substantially exactly that amount.

3) The V-GEN System provides networked monitoring of the exact power being provided by generating equipment, therefore the amount of power being displaced on the ISO's grid though real-time reporting/feedback.

4) The V-GEN System provides centralized aggregation of the production of all the generators to a web server for real-time status updates and changes in response to the prevailing conditions for deployment. For example, the system can maintain a tie to the transmission system controller and adjust the response as needed. Other, manual systems do not allow for this, and consequently the deployment could have short falls or overages with no ability to adjust.

5) The V-GEN System maintains automated centralized accounting systems showing run-time values and monitored demand reductions for monthly billing and real-time updates through the internet. This will be accessible by building owners and participating generation, transmission, and distribution operators.

6) The V-GEN System enables constant monitoring of power quality as well as generator output, enabling the diversion of generating requirements from generators producing low quality power to other generators in the dispatch sequence.

7) Both local and national responses are deployed from the same central V-GEN server for multiple subscribing external system operators and multiple end-users.

8) Additional economic value is created by using the deployment of emergency generators to also satisfy the functional requirements for periodic testing of the generators. Data on the run-time of the emergency generators will be compiled and represented in a standard maintenance log for organizational requirements such as the “Joint Commissions” for hospital groups. The programming for deployment will establish a “floor” for deployment to meet testing and maintenance requirements while optimizing the economic output of the generator.

9) The V-GEN Control Panels for automated response to the Hub signals will be mounted on both already-installed generators and via original equipment manufacturer's (OEMs) agreement with generator manufacturers to enable them to demonstrate a return on their equipment.

Technique 2. End Use Equipment Demand Control

In the second exemplary technique, facility end use equipment, such as chillers, fans, and lighting, is controlled in one of two ways:

1) The end use equipment is staged to reduce load, i.e., it is operated in controlled sequences which causes the total load during peak periods to approximate the average load during peak periods, thereby reducing the maximum load.

2) The end use equipment is throttled back to reduce load. Under normal circumstances, such equipment operates to keep building environments within generally accepted, prescribed comfort “envelopes”. Building occupants, however, generally tolerate quite well (and usually do not notice) short-lived migrations out of the comfort envelopes. Throttling back the equipment enables the user of the invention to reduce the power requirements of the equipment, thereby enabling the facility to shed load. In addition, users of the invention can take measures (such as pre-cooling the thermal mass of a building) to mitigate the impact of such migrations on the comfort conditions of the building.

In an exemplary application, the customer will be able to monitor the current real-time demand for the facility. The V-GEN panel will react to signals from the V-GEN Hub. If the measured real-time demand exceeds the parameters signaled from the Hub the V-GEN Control Panel will deploy the programmed routines to maintain and reduce load. This control strategy the product of an engineering evaluation of each individual facility. This evaluation will model the facility utilizing the Modified BIN profile (Department of Energy standard). The model can serve as the basis of programming strategies to reduce demand without sacrificing operational aspects like indoor air quality, temperature, and humidity control. Programmed strategies are, e.g., the altering of standard operation of a building system to immediately reduce the demand for a specified period of time.

The V-GEN panel will record and report the effect of the deployed strategy. This data will be used to account for the overall demand reduction accomplished by the exercised strategy. The system will use the data recorded to survey other scenarios for demand reductions.

Any and all data measured by a V-GEN controller locally will be transmitted electronically via a RF signal device, ethernet or modem to a third party data warehouse (contracted by V-GEN) which will incorporate a current approved utility rate engine applicable to specific local or regional rate structures—whether regulated or deregulated. This data will be compiled and processed by the third party, according to V-GEN's specifications, and will be accessible via a thin client internet site to all V-GEN authorized customers, which may include the ISO's, Utility Companies, Public Utility Commissions, and the Host Power Users. Reports in the form of bills can be downloaded as well as cost to date statements. This will be in the form of two charging structures; (1) load curtailment for the ISO and (2) demand limitation for the power user. Load curtailment will be an aggregate of all activities within the specific electric grid (with an electronic date and time stamp) and an approved rate engine for unit pricing. It is assumed at this point, any load curtailment will be viewed as “generation produced”. Any demand limited by the system will be cost avoided for the power user.

It is understood that the examples and embodiments described herein are for illustrative purposes only and that various modifications or changes in light thereof will be suggested to persons skilled in the art and are to included within the spirit and purview of this application and are considered within the scope of the appended claims. All publications, patents, and patent applications cited herein are hereby incorporated by reference in their entirety for all purposes.

What is claimed is:

1. A method for deploying distributed load reduction within an power supply network, said method comprising:
(a) sending a first electronic signal from a signal hub to a device within a power user's facility, wherein said device is a member selected from generating equipment and power using devices, said signal activating or deactivating said device;
(b) sending a confirming electronic signal from said device to said signal hub to confirm that said device is activated or deactivated in response to said first signal; and
(c) sending a second signal from said signal hub to said device to activate or deactivate said device.

2. The method according to claim 1, wherein a member selected from said first signal, said confirming signal, said second signal and combinations thereof are delivered using a wide area network.

3. The method according to claim 2, wherein said wide area network is the Internet.

4. The method according to claim 2, wherein said member is delivered using TCP/IP.

5. The method according to claim 1, wherein said device is activated or deactivated in response to a member selected from the group consisting of load conditions within said power user's facility, within a generation system, within a transmission system and combinations thereof.

6. The method according to claim 1, wherein more than one device in said power user' facility is activated or deactivated in response to said first signal.

7. The method according to claim 1, wherein a device in more than one power user's facility is activated or deactivated in response to said first signal.

8. The method according to claim 1, wherein said signal hub is hotlinked to one or more computer systems controlling a member selected from the group consisting of external transmission systems, external generating systems and combinations thereof.

9. A method for deploying distributed load reduction within an power supply network by remotely activating an power generating device within a power user's facility, said method comprising:
(a) sending a first electronic signal from a signal hub to a power generating device within a power user's facility, thereby activating said device;
(b) sending a confirming electronic signal from said device to said signal hub to confirm that said device is activated in response to said first signal; and
(c) sending a second signal from said signal hub to said device to deactivate said device.

10. The method according to claim 9, wherein a member selected from said first signal, said confirming signal, said second signal and combinations thereof are delivered using a wide area network.

11. The method according to claim 10, wherein said wide area network is the Internet.

12. The method according to claim 10, wherein said member is delivered using TCP/IP.

13. The method according to claim 9, wherein said device is activated or deactivated in response to a member selected from the group consisting of load conditions within said power user's facility, within a generation system, within a transmission system and combinations thereof.

14. The method according to claim 9, wherein said activating said device utilizes a start sequence that includes actuation of an auto transfer switch thereby, thereby disengaging utility-provided power.

15. The method according to claim 9, wherein said first signal and said second signal are transmitted from said signal hub to a V-GEN control panel operatively linked to said generating equipment, and said confirming signal is sent from said V-GEN control panel to said signal hub.

16. The method according to claim 9, wherein said V-GEN control panel monitors power output of said generating equipment and, using monitored output prepares a calculated real time load on said generating equipment.

17. The method according to claim 16, wherein said calculated real time load is transmitted to said signal hub.

18. The method according to claim 17, wherein said signal hub continuously monitors said calculated load and responds to increases in said load by a member selected from the group consisting of deploying additional power generating equipment, providing additional utility-provided power, deactivating power using equipment within said power user's facility and combinations thereof.

19. The method according to claim 17, wherein said signal hub continuously monitors said calculated load and responds to decreases in said load by a member selected from the group consisting of deactivating power generating equipment, decreasing utility-provided power, activating power using equipment within said power user's facility and combinations thereof.

20. A method for deploying distributed load reduction within an power supply network by remotely deactivating an power using device within a power user's facility, said method comprising:
(a) sending a first electronic signal from a signal hub to an power using device within a power user's facility, thereby deactivating said device;
(b) sending a confirming electronic signal from said device to said signal hub to confirm that said device is deactivated in response to said first signal; and
(c) sending a second signal from said signal hub to said device to activate said device.

21. The method according to claim 20, wherein a member selected from said first signal, said confirming signal, said second signal and combinations thereof are delivered using a wide area network.

22. The method according to claim 21, wherein said wide area network is the Internet.

23. The method according to claim 21, wherein said member is delivered using TCP/IP.

24. The method according to claim 20, wherein said device is activated or deactivated in response to a member selected from the group consisting of load conditions within said power user's facility, within a generation system, within a transmission system and combinations thereof.

25. The method according to claim 20, wherein said activating said device utilizes a start sequence that includes actuation of an auto transfer switch thereby, thereby disengaging utility-provided power.

26. The method according to claim 20, wherein said first signal and said second signal are transmitted from said signal hub to a V-GEN control panel operatively linked to said generating equipment, and said confirming signal is sent from said V-GEN control panel to said signal hub.

27. The method according to claim 20, wherein said V-GEN control panel monitors power output of said generating equipment and, using monitored output prepares a calculated real time load on said generating equipment.

28. The method according to claim 27, wherein said calculated real time load is transmitted to said signal hub.

29. The method according to claim 28, wherein said signal hub continuously monitors said calculated load and responds to increases in said load by a member selected from the group consisting of deploying additional power generating equipment, providing additional utility-provided power, deactivating power using equipment within said power user's facility and combinations thereof.

30. The method according to claim 28, wherein said signal hub continuously monitors said calculated load and responds to decreases in said load by a member selected from the group consisting of deactivating power generating equipment, decreasing utility-provided power, activating power using equipment within said power user's facility and combinations thereof.

31. A system for deploying distributed load reduction within an power supply network, said system comprising:
(a) a signal hub comprising:
(i) a V-GEN Hub, which dispatches start and stop signals to power generating and power using equipment in a power user's facility, and data-logs responses from equipment in said power user's facility; and
(ii) a V-GEN Server, which receives a signal from a member selected from an external generating system, an external transmission system and combinations thereof, wherein if said signal is above a predetermined threshold, said Server transmits deployment instructions to said V-GEN Hub; and
(b) a V-GEN Control Panel operatively linked to said signal hub and an power generating device or an power using device in said power user's facility, said control panel transmitting said deployment instructions to said device and transmitting said responses to said V-GEN Hub.

32. The system according to claim 31, wherein said signal hub transmits signals to more than one device in a power user's facility.

33. The system according to claim 31, wherein said signal hub transmits signals to more than one power user's facility.

34. The system according to claim 31, further comprising a means for automated centralized accounting of power generated and power used by a power user's facility.
